(19) United States
(12) Patent Application Publication
(10) Pub. No.: US 2007/0127052 A1
(43) Pub. Date: Jun. 7, 2007

(54) ELECTRONIC RECOVERY SYSTEM AND METHOD

(75) Inventor: Pi-Yuan Cheng, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/462,081

(22) Filed: Aug. 3, 2006

Related U.S. Application Data
(60) Provisional application No. 60/742,595, filed on Dec. 6, 2005.

(51) Int. Cl. G06K 15/00

(52) U.S. Cl. 358/1.14; 358/1.15

(57) ABSTRACT

An electronic system capable of automatically recovering from an abnormal condition. The electronic system comprises a target device, a memory module, a driving device and a processor. The memory module stores a plurality of settings for the target device. The driving device directs operations of the target device according to the settings stored in the memory module. The processor, coupled to the driving device, checks the settings in the memory module to determine whether the settings have been abnormally changed and corrects the settings in the memory module when the settings have been abnormally changed.

### BACKGROUND OF THE INVENTION

1. Field of the Invention

The invention relates to electronic recovery, and more specifically to an electronic system capable of automatically recovering from abnormal conditions and a method thereof.

2. Description of the Related Art

Electronic devices may operate abnormally due to various reasons such as design bugs. An electronic system may comprise a large number of components to achieve desired functions. Generally, one or more memory module, such as a register or a RAM buffer, is built into an electronic system. The data stored in the memory module only changes in response to certain signals. However, it may change abnormally due to manufacturing variations, electrostatic discharge (ESD) and so on. Thus, the electronic system may malfunction or even crash due to incorrect data stored in the memory module. Thus, it is advantageous to obtain an electronic system capable of automatically detecting an abnormal condition and recovering therefrom.

### BRIEF SUMMARY OF THE INVENTION

A detailed description is given in the following embodiments with reference to the accompanying drawings.

The invention is generally directed to an electronic system capable of automatically recovering from an abnormal condition. An exemplary embodiment of an electronic system comprises a target device, a memory module, a driving device and a processor. The memory module stores a plurality of settings for the target device. The driving device directs operations of the target device according to the settings stored in the memory module. The processor, coupled to the driving device, checks the settings in the memory module to determine whether the settings have been abnormally changed and if so, corrects them.

A method for automatically recovering an electronic system having a driving device and a target device from an abnormal condition is provided. The method comprises checking a plurality of settings stored in a memory module to determine whether an abnormal condition has occurred, whereupon the driving device directs operations of the target device according to the settings and correcting the settings as required.

### BRIEF DESCRIPTION OF THE DRAWINGS

The invention can be more fully understood by reading the subsequent detailed description and examples with references made to the accompanying drawings, wherein:

FIG. 1 is a schematic diagram of an electronic system according to an embodiment of the invention.

FIG. 2 is a flowchart of a method for automatically recovering an electronic system from an abnormal condition according to an embodiment of the invention.

FIG. 3 is a schematic diagram of an electronic system which is a mobile phone according to an embodiment of the invention.

FIG. 4 is a schematic diagram illustrating a general architecture of a mobile phone software system of the mobile phone of FIG. 3.

FIG. 5 is a state machine example for designing driver logic.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

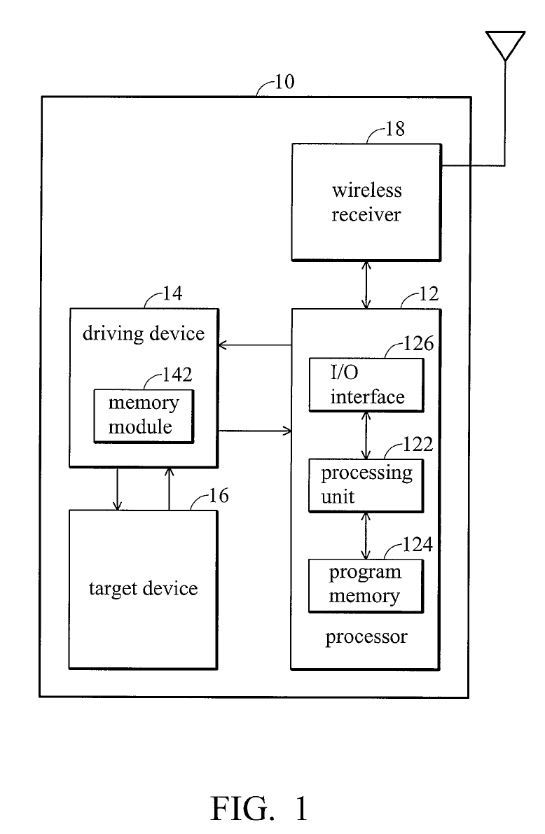

FIG. 1 is a schematic diagram of an electronic system 10 according to an embodiment of the invention, comprising a processor 12, a driving device 14, and a target device 16. The processor 12 comprises a processing unit 122, a program memory 124 and an input/output (I/O) interface 126. The processing unit 122 executes program code stored in the program memory 124 and communicates with the target device 16 via the I/O interface 126 and driving device 14. The driving device 14 comprises a memory module 142, such as a register, to store configuration settings for the processor 12 to drive the target device 16. The memory module 142 comprises at least one register and the settings comprise environment variables for directing operations of the target device 16. When the electronic system 10 is initialized, the processing unit 122 executes an initialization code stored in the program memory to initialize the settings in the memory module 142, allowing the target device 16 to operate properly. Moreover, during operation of the electronic system 10, the processor 12 may change settings in the memory module 142 when necessary, allowing the target device 16 to operate in a desired mode or execute desired function of the target device 16. When setting the settings in the memory module 142, the processor 12 stores a backup copy of the settings as reference settings. The processor 12 retrieves the settings from the memory module 142 and compares the retrieved settings to the reference settings thereof to determine whether the settings in the memory module 142 have been abnormally changed. If the retrieved settings are inconsistent with the reference settings, implying settings have changed unexpectedly, the processor 12 replaces the settings in the memory module 142 with the reference settings. It is not necessary to store all the settings as reference settings or compare all the settings in the memory module 142 to the reference settings. A part of the settings may be reserved as reference settings according to design necessity, similarly, only a part of the settings in the memory module 142 are compared to the reference settings so that detection of abnormal conditions can be faster and finished in a certain time period. The processor 12 may check the settings in the memory module 142 periodically or only when triggered by an event. For example, if the target device 16 is a display module, the processor 12 may check the settings in the memory module 142 when the target module 142 is refreshed. Alternatively, when the target device 16 operates in sleep mode and is awakened, the processor 12 may check the settings in the memory module 142 at that time. The electronic system 10 further comprises a wireless receiver 18. The wireless receiver, coupled to the processor 18, periodically receives a periodical signal and the timing of the processor 12 to check the settings in the memory module 142 can be set to align with the periodical signal, wherein the wireless receiver may be a GSM module and the periodical signal is a paging signal.

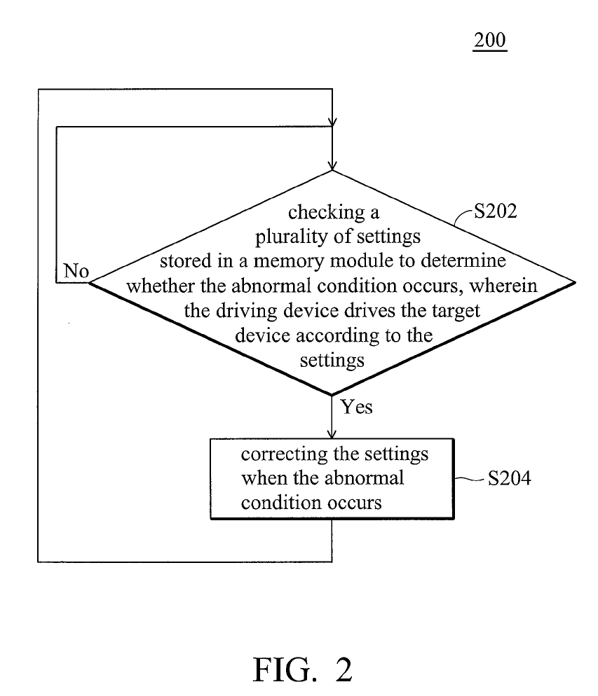

FIG. 2 is a flowchart of a method 200 for automatically recovering an electronic system from abnormal conditions according to an embodiment of the invention, wherein the electronic system comprises a driving device and a target device. The method 200 may be implemented as a set of code for a processor to execute or as logic circuit built into the driving device. In the step 202, a plurality of settings stored in a memory module is checked to determine whether an abnormal condition has occurred, wherein the driving device directs operations of the target device according to the settings stored in a memory module, which may comprise environment variables. The settings are retrieved from the memory module and compared to a plurality of reference settings stored previously, wherein the reference settings are a copy of settings reserved when the settings in the memory module are set during initialization or operation. Retrieved settings inconsistent with the reference settings indicate an abnormal change. If so, the method 200 proceeds to step 204. If not, the method 200 returns to step 202 to detect any abnormal condition again. The checking of settings to determine whether the abnormal condition has occurred is periodically performed with a hardware or software timer. It may also be triggered by an event. For example, when the target device is a display module, the trigger may comprise display refreshing or driving device awakening. Alternatively, the timing of checking the settings to determine whether the abnormal condition has occurred may be substantially aligned with a periodical signal received by a wireless receiver of the electronic system, wherein the wireless receiver is a GSM module and the periodical signal is a paging signal. Moreover, it is not necessary to store all the settings but only a part thereof. Further, in comparison of settings retrieved from the memory module with the reference settings, not all the settings are required for comparison, such that the comparison is faster and finished in a predetermined time period. In step 204, the settings in the memory module are corrected when the abnormal condition has occurred, by replacing the settings in the memory module with the reference settings. Following step 204, the method 200 returns to step 202 to continue further detection of the abnormal condition. The invention can be utilized in various applications as follows.

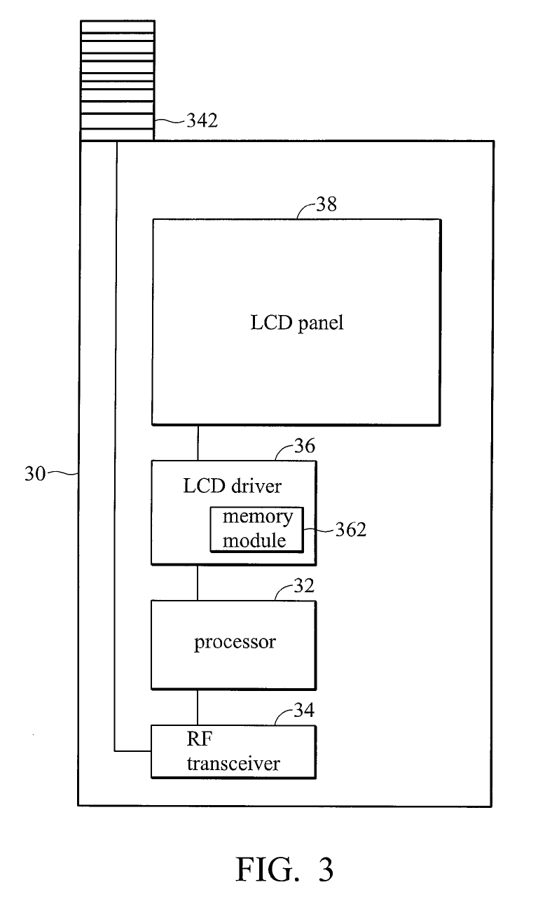

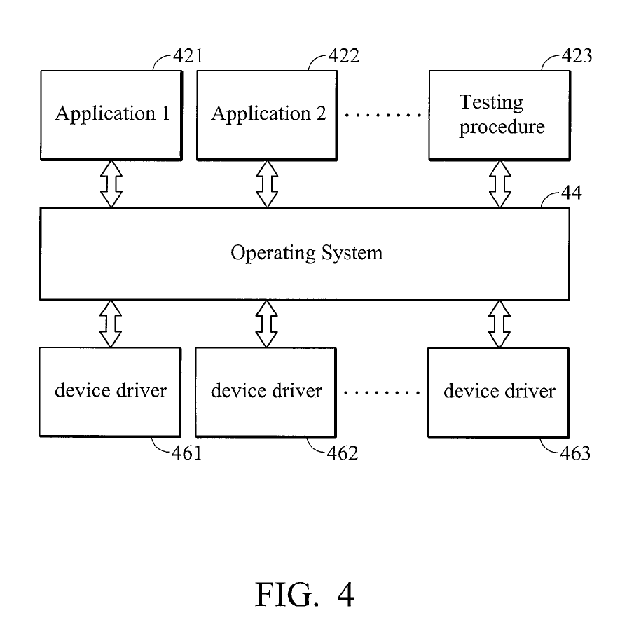

FIG. 3 is a schematic diagram of an electronic system 30 which is a mobile phone according to an embodiment of the invention, comprising a processor 32, a radio frequency (RF) transceiver 34 coupled to an antenna 34, a liquid crystal display (LCD) driver 36, and a LCD panel 38. FIG. 4 is a schematic diagram illustrating a general architecture of a mobile phone software system of the mobile phone 30, executed by the processor 32. In this embodiment, applications 421, 422 and a test procedure 423 are running on an operating system 44. When the applications 421, 422 need to communicate with hardware devices, corresponding device drivers 461, 462 and 463 are executed to allow corresponding devices to provide desired functions. In practice, the operating system 44 may be designed with multiple layers, each layer providing certain functions. The applications 421, 422 may include a plurality of functions registered in the operating system 44 so that when an event or interrupt occurs, associated functions are activated. Various organizing software can be used in a mobile phone system. For example, the operating system 44 may be implemented as a simple task-management system, and the software in the mobile phone system comprises many tasks. When a task accesses a hardware device, such as the keypad of the mobile phone, a corresponding software driver is activated to handle the request.

With reference to FIG. 3, the LCD driver 36 may be combined with the LCD panel 38 as a module for sale or as a single module to be incorporated into the processor 32. The LCD driver 36 comprises a memory module 362 storing register settings, allowing the LCD panel 38 to operate properly. For example, the settings may comprise a register representing pixel color format, such as RGB565 or RGB666. For pixel color format RGB565, the color of a pixel is represented by 16 bits set by the processor 32, wherein 5 bits are for red, 6 bits are for green and 5 bits are for blue. For pixel color format RGB666, the color of a pixel is represented by 18 bits set by the processor 32, wherein 6 bits are for red, 6 bits are for green and 6 bits are for blue. The processor 32 sets the register settings in the memory module 362 during initialization of the mobile phone 30 or during operation thereof when necessary. When setting the register settings, the processor 32 reserves a copy of the register settings as reference settings. The processor 32 retrieves the register settings from the memory module 362 to compare with the reference settings. Since the processor 32 updates the reference settings when setting the register settings, the register settings retrieved from the memory module 362 should be consistent with the reference settings. Hence, if the register settings in the memory module 362 are unexpectedly changed, the processor 32 can detect the abnormal condition and accordingly correct it by replacing the register settings in the memory module 362 with the reference settings. As stated, the processor 32 may check the register settings periodically with a timer or it may be triggered by an event. For example, the checking of settings can be triggered when the LCD panel 38 is refreshed or when the LCD driver 36 is awakened. Further, if the mobile phone is a GSM mobile phone, since the system thereof awakens periodically to receive a paging signal, determining whether there is an incoming call when in sleep mode, a timer is used to periodically check the register settings, aligning with the paging signal. Thus, additional power consumption is avoided. To ensure that the GSM mobile phone is able to return to the sleep mode again, the period of the timer can be set to exceed that of the paging signal, such as 2, 3 or 10 seconds. Further, to reduce power consumption, not all the register settings and/or image buffer storing information of pixels of the LCD panel 38 are required to be checked. A certain set of register settings are selected to determine whether abnormal condition has occurred. With an appropriate period of checking the register settings in the memory module 362 or selecting an appropriate set of register settings for checking, the performance of the GSM mobile phone improves with reduced power consumption.

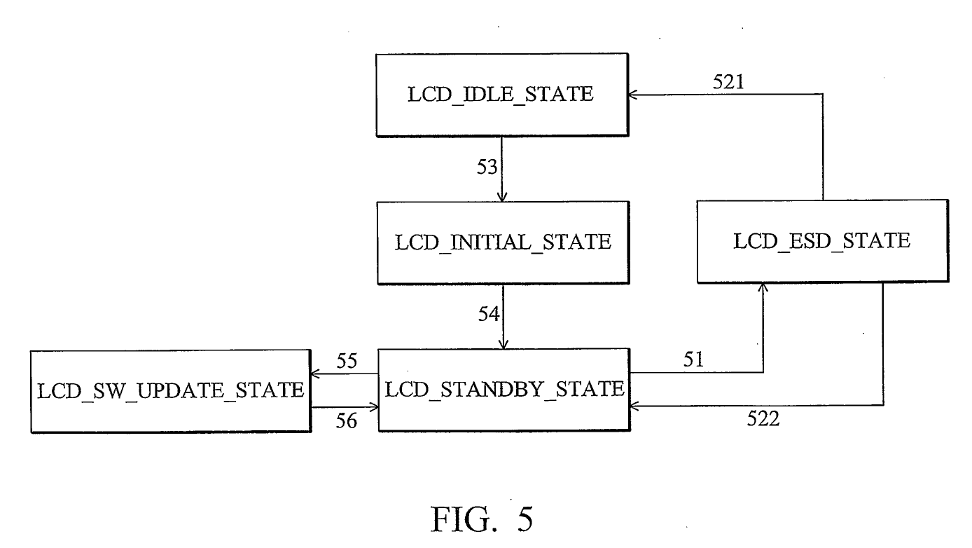

FIG. 5 illustrates a state machine for depicting the state machine of a LCD driver program, in which the check and recovery program is incorporated. When a system, e.g. the mobile phone system depicted in FIG. 3, is initialized, a driver program enters LCD_IDLE_STATE and LCD_INITIAL_STATE, for initializing corresponding register settings and frame buffers (step 53). When initialization is done, the driver enters LCD_STANDBY_STATE (step 54). In this example, a timer is set for triggering the check and recover program (step 51). When the timer is time out, the check and recover program enters a LCD_ESD_STATE and in this state, the check and recover program checks the register settings and corresponding data of the LCD driver IC 36. If the check result indicates that the register settings or other data are changed abnormally, the driver enters LCD_IDLE_STATE (step 521) and resetting the LCD driver IC 36. Otherwise, the driver returns to LCD_STANDBY_STATE (step 522); where other tasks may access the LCD driver IC 36 via the driver, e.g. drawing pictures on the LCD panel 38 (step 55). When tasks are done, the driver returns to LCD_STANDBY_STATE (step 56).

Since the mobile phone 30 is carried by users for a long time, it is easily damaged by ESD. This becomes more serious when the LCD panel 38 is overlapped with a touch panel. If the color format register setting is affected by an ESD event, for example, changing values of register settings, the display of the LCD panel 38 is affected immediately with incorrect color format setting,. Conventionally, the mobile phone device 30 requires resetting, degrading efficiency. Though many ESD protection circuits are provided to avoid damage from ESD, other mechanisms are required to improve robustness of the mobile phone 30. The invention enables the mobile phone 30 to recover automatically from abnormal conditions such as ESD, reducing burden of users and improving efficiency.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic system capable of automatically recovering from an abnormal condition, the electronic system comprising:
a target device;
a memory module, storing a plurality of settings for the target device;
a driving device, driving the target device according to the settings stored in the memory module; and
a processor coupled to the driving device, checking the settings in the memory module to determine whether the settings have been abnormally changed and correcting the settings in the memory module when the settings have been abnormally changed.

2. The electronic system as claimed in claim 1, further comprising a wireless receiver coupled to the processor, receiving a periodical signal wherein the timing of the processor to detect the abnormal changes of the settings is substantially aligned with the periodical signal.

3. The electronic system as claimed in claim 2, wherein the wireless receiver is a GSM module and the periodical signal is a paging signal.

4. The electronic system as claimed in claim 1, wherein the processor executes a set of initialization codes to initialize the settings stored in the memory module when the electronic system is initialized.

5. The electronic system as claimed in claim 1, wherein the processor stores at least a part of the values of the settings as a plurality of reference values and compares the reference values with the settings stored in the memory module to detect the abnormal changes of the settings.

6. The electronic system as claimed in claim 5, wherein some of the settings are checked to allow the checking of the settings to finish in a predetermined time period.

7. The electronic system as claimed in claim 1, wherein the memory module comprises at least one register and the settings comprise a plurality of environment variables for driving the target device.

8. The electronic system as claimed in claim 1, wherein the memory module comprises a display memory and the settings comprise an image data format.

9. The electronic system as claimed in claim 1, wherein the processor checks the settings periodically.

10. The electronic system as claimed in claim 1, the processor checks the settings when an event of operating the target device occurs.

11. The electronic system as claimed in claim 10, wherein the target device is a display module and the event is display module refreshing.

12. The electronic system as claimed in claim 10, wherein the target device is a display module and the event is the driver device awakening.

13. A method for automatically recovering an electronic system having a driving device and a target device from an abnormal condition, the method comprising:
checking a plurality of settings stored in a memory module to determine whether the abnormal condition has occurred, wherein the driving device drives the target device according to the settings; and
correcting the settings when the abnormal condition has occurred.

14. The method as claimed in claim 13, wherein the timing of checking the settings to determine
whether the abnormal condition has occurred is substantially aligned with a periodical signal received by a wireless receiver of the electronic system.

15. The method as claimed in claim 14, wherein the wireless receiver is a GSM module and the periodical signal is a paging signal.

16. The method as claimed in claim 13, further comprising storing at least a part of values of the settings as a plurality of reference values before checking.

17. The method as claimed in claim 16, wherein at least a part of values of the settings as a plurality of reference values is stored when the electronic system is initialized.

18. The method as claimed in claim 16, wherein the checking comprises retrieving the settings from the memory module and comparing the reference values with the retrieved settings to detect abnormal changes in the settings.

19. The method as claimed in claim 18, wherein some of the settings are checked to allow checking of the settings to finish in a predetermined time period.

20. The method as claimed in claim 13, wherein the memory module comprises at least one register and the settings comprises a plurality of environment variables for driving the target device.

21. The method as claimed in claim 13, wherein the memory module comprises a display memory and the settings comprise an image data format.

22. The method as claimed in claim 13, wherein checking the settings to determine whether the abnormal condition has occurred is performed periodically.

23. The method as claimed in claim 13, wherein checking the settings to determine whether the abnormal condition has occurred is performed when an event of operating the target device occurs.

24. The method as claimed in claim 23, wherein the target device is a display module and the event is display module refreshing.

25. The method as claimed in claim 21, wherein the target device is a display module and the event is the driver device awakening.
